(19) United States
(12) Patent Application Publication
(10) Pub. No.: US 2026/0235367 A1
(43) Pub. Date: Aug. 13, 2026

(54) METHOD AND SYSTEM FOR CONTROLLING A STATE-OF-CHARGE OF PHASE CHANGE MATERIAL STORAGE SYSTEMS

(71) Applicant: CARTESIAN AS, Trondheim (NO)

(72) Inventors: Alexis SEVAULT, Trondheim (NO); Olav GALTELAND, Trondheim (NO); Magnus ROTAN, Trondheim (NO); Ragnhild SÆTERLI, Trondheim (NO); Fride VULLUM-BRUER, Trondheim (NO)

(21) Appl. No.: 19/155,992

(22) PCT Filed: Feb. 14, 2024
(86) PCT No.: PCT/NO2024/050037

§ 371 Date: Aug. 13, 2025

(30) Foreign Application Priority Data
Feb. 15, 2023 (NO) 20230150

(51) Int. Cl. F28D 20/02; F28D 20/00

(52) U.S. Cl. CPC F28D 20/028; F28D 2020/0078; F28D 2020/0091

(57) ABSTRACT

A method for measuring a state of charge of a phase change material thermal energy storage system and optimising the system thereto, comprising: propagating a wave through at least a majority of a phase change material along a thermal gradient of the phase change material thermal energy storage system, wherein a property of said wave is dependent on the medium through which it propagates; detecting the emerging wave after it has propagated through at least the majority of the phase change material along the thermal gradient; determining a wave parameter of the emerging wave, said wave parameter associated with a liquid fraction of the phase change material; calculating a ratio between a liquid and solid state of the phase change material using the wave parameter associated with the liquid fraction; using the calculated ratio to estimate a state of charge of the phase change material thermal energy storage system at a time of propagation of the emergent wave.

### CROSS-REFERENCE TO RELATED APPLICATION(S)

This is a national stage application filed under 37 U.S.C. 371 based on International Patent Application No. PCT/NO2024/050037, filed Feb. 14, 2024, which claims priority to Norwegian Patent Application No. 20230150 filed Feb. 15, 2023, the entire contents of which are incorporated herein by reference in their entirety.

### FIELD OF THE INVENTION

The invention relates to phase change material storage systems and, in particular, mechanism for measuring a state-of-charge of said phase change material storage systems and controlling the system accordingly.

### BACKGROUND

Phase change materials (PCMs) are ideal for use in any application where a storage and release of thermal energy is desired. PCMs act like a battery for heat energy because they absorb heat energy as they melt and can be “recharged” by cooling them until they crystallise and give the stored energy back to the environment. They can store and release heat energy thousands of times without change in thermal properties. Such deferred use of stored energy can reduce strain on a power grid and/or reduce the average cost of energy per kilowatt-hour during peak load periods.

Typically, a PCM thermal energy storage system (TES) comprises a container, a heat exchanger disposed within the container, and a PCM disposed within the container such that the heat exchanger is immersed in the PCM. A TES can either absorb or release energy via a phase transition of its PCM. The TES may be attached to an external source of a thermal fluid providing a heat exchange fluid which may have a high heat capacity.

The external fluid participates in thermal energy transfer or heat exchange with the PCM disposed in the container. For example, the external fluid may transfer thermal energy or heat to the PCM, thereby lowering the temperature of the external fluid. The PCM stores the transferred thermal energy as latent heat (e.g., by undergoing a phase transition, such as a transition from a solid state to a liquid state). Alternatively, stored latent heat from the PCM may be transferred to the external fluid, thereby increasing the temperature of the external fluid. In this manner, a TES can store thermal energy during a first time interval and release it during a second time interval. For example, the system can store thermal energy when the PCM of the system is exposed to a relatively warm external fluid, where the relative warmth of the external fluid is based on the external fluid having a temperature that is greater than the relevant phase transition temperature of the PCM and greater than the temperature of the PCM. The system can release the stored thermal energy when the PCM of the system is later exposed to a relatively cool external fluid. Again, the relative coolness of the external fluid is based on the external fluid having a temperature that is lower than the temperature of the PCM at the time of thermal contact. Such a pattern of storing and releasing of thermal energy can be especially useful when it is desired to cool the external fluid during the first time interval. Many systems can benefit from the use of PCM heat exchangers for thermal energy storage, for example to provide heat removal.

The degree of charge of the TES cannot be determined by temperature measurements alone since a degree of charge of a PCM TES is mainly determined by the ratio between a liquid state and solid state of the PCM.

Thus, it is an object of the invention to provide a method and system to determine a proportion of liquid and solid in the PCM of a PCM TES and thereby optimise (control) a TES output accordingly.

### SUMMARY OF THE INVENTION

According to a first aspect of the invention there is provided a method for measuring a state of charge of a phase change material thermal energy storage system and optimising the system thereto, comprising: propagating a wave through at least a majority of a phase change material along a thermal gradient of the phase change material thermal energy storage system, wherein a property of said wave is dependent on the medium through which it propagates; detecting the emerging wave after it has propagated through at least the majority of the phase change material along the thermal gradient; determining a wave parameter of the emerging wave, said wave parameter associated with a liquid fraction of the phase change material; calculating a ratio between a liquid and solid state of the phase change material using the wave parameter associated with the liquid fraction; using the calculated ratio to estimate a state of charge of the phase change material thermal energy storage system at a time of propagation of the emergent wave.

The method may further comprise controlling a heat output of the phase change material thermal energy storage system based on the calculated state of charge, wherein controlling the heat output comprises: adjusting the temperature of a circulating fluid upstream from the thermal energy storage system; and/or adjusting the flow rate of a circulating fluid upstream from the thermal energy storage system; and/or adjusting the pressure of a circulating fluid upstream from the thermal energy storage system.

The method may further comprise continually repeating the above steps for continual monitoring of the state of charge of the phase change material thermal energy storage system and corresponding continuous control of the heat output.

The continual monitoring of the state of charge and the continuous control of the heat output may occur in real-time or periodically.

The wave to be propagated through at least the majority of the phase change material may be an ultrasound wave, and the corresponding wave parameter is a speed of sound.

The wave to be propagated through at least the majority of the phase change material may be an electromagnetic wave in the visual or ultraviolet spectrum, and the corresponding wave parameter is a light intensity.

The method may further comprise an additional signal processing step to extract the speed of sound from a signal of the emergent ultrasound wave.

The additional signal processing step may comprises performing a low pass filter on the signal; performing a Fourier transform on the low pass filter processed data to identify a signal peak; and deriving a time-of-flight of the propagating wave.

The method may further comprise measuring a sensible temperature via a thermocouple and incorporating the sensible temperature measurement for calculating the state of charge.

The method may further comprise using a combination of ultrasound waves and electromagnetic waves.

According to a second aspect of the invention there is provided a method of controlling a functioning of a phase change material thermal energy storage system having a variable heat output, comprising: a), performing the steps of the first aspect of measuring a state of charge of a phase change material thermal energy storage system; and b) retrieving a range of heat output rates for the measured state of charge at the corresponding time interval from a database; c) comparing a heat output of the thermal energy storage system with the retrieved range of heat output rates for the measured state of charge at the corresponding time interval; and d) when it is determined that the heat output is outside the retrieved range, adjusting the heat output to lie within the retrieved range at the corresponding time interval; and repeatedly performing steps a to d at predetermined time intervals to continuously control a heat output of the phase change material thermal energy storage system.

The method of the second aspect may further comprising continuously recording state of charge, retrieved heat output rate range and real heat output for each predetermined time interval; tracking a first trend in the state of charge of the thermal energy storage system over time; tracking a second trend in real heat output compared to the retrieved heat output rates; and feeding the first and/or second trends into a machine learning program to predict future values in state of charge and/or real heat output; and incorporating the machine learning predictions into controlling a functioning of a phase change material thermal energy storage system.

According to a third aspect of the invention there is provided a system for measuring a state of charge of a phase change material thermal energy storage system and optimising thereto, comprising: at least one wave transmitter of a first type; at least one wave receiver of a first type; wherein each of the at least one transmitter and each of the at least one receiver are configured to lie along a thermal gradient; a signal processing module comprising instructions that, when executed on a processor, perform the steps of: converting a wave signal into a state of charge; and a control module for controlling a functioning of the phase change material thermal energy storage system.

The system may further comprise at least one thermocouple and wherein the signal processing module further comprises instructions that, when executed on a processor, perform the step of utilising the voltage measured by the thermocouple to provide a more accurate estimate of the total state of charge of the phase change material thermal energy storage system.

The at least one wave transmitter of a first type may be an ultrasound transducer, and the at least one wave receiver of a first type may be an ultrasound detector.

The at least one wave transmitter of a first type may be a light-emitting diode, and the at least one wave receiver of a first type may be a photoresistor.

The system may further comprise at least one transmitter of a second type wherein the at least one wave transmitter of a first type is a light-emitting diode, and at least one wave receiver of a second type wherein the at least one wave receiver of a first type is a photoresistor.

According to a fourth aspect of the invention there is provided a system for controlling a functioning of a phase change material thermal energy storage system having a variable heat output, comprising: the system of the third aspect; a database comprising a plurality of predefined heat output rates ranges for a plurality of corresponding state of charge values; and wherein the control module further comprises: a comparison module comprising computer readable media with instruction that, when executed on a processor, perform the task of comparing a heat output of the thermal energy storage system with the retrieved range of heat output rates for the measured state of charge at the corresponding time interval; and wherein, when it is determined that the heat output is outside the retrieved range, the control module is further configured to adjusting the heat output to lie within the retrieved range at a corresponding time interval.

The system of the fourth aspect, wherein the control module further comprises: a trend tracking module comprising computer readable media with instruction that, when executed on a processor, perform the task: tracking a first trend in the state of charge of the thermal energy storage system over time; and/or tracking a second trend in real heat output compared to the retrieved heat output rates; and a machine learning module configured to utilise the first and/or second trends to create predictions on a further state of charge/heat output of the system and control a functioning of a phase change material thermal energy storage system accordingly.

According to a fifth aspect of the invention there is provided a self-monitoring phase change material thermal energy storage system comprising: a container; a phase change material contained within said container; at least one heat sink or heat source at in a first end location of in the container; at least another a heat sink or heat source at a second, opposite end of location in the container at a distance from the at least one heat sink or heat source; and the system of the third or fourth aspect of the invention wherein each of the at least one transmitter is located proximate to the at least one heat source or heat sink and each of the receivers is located proximate to the at least another heat sink or heat source and laterally aligned such that each of the at least one transmitter and each of the at least one receiver are configured to lie along a thermal gradient.

The thermocouple may be substantially centrally located within the phase change material.

According to a sixth aspect of the invention there is provided a pillow plate type self-monitoring phase change material thermal energy storage system comprising: a plurality of parallel plates each plate comprised of two sheets welded together with a pattern of embossed impressions; the system of any of the third to the fifth aspect of the invention; wherein the at least one wave transmitter of a first type comprises a plurality of wave transmitters of the first type, positioned in at least two of embossed impressions of at least a first plate of the plurality of parallel plates; and wherein the at least one wave receiver of a first type comprises a plurality of corresponding wave receivers of the first type, positioned in at least two of the embossed impressions of a neighbouring plate of the first plate.

According to a sixth aspect of the invention there is provided an extruded tube-in-tube type self-monitoring phase change material thermal energy storage system comprising: an inner tube, an outer tube and a plurality of internal fins which extend radially from the inner tube to the outer tube; the system of any of the third to the fifth aspect of the invention; wherein at least one wave transmitter is affixed to an outer surface of the inner tube and is axially and radially aligned with at least one wave receiver affixed to an inner surface of the outer tube, creating at least one transmitter-receiver pair.

### BRIEF DESCRIPTION OF THE DRAWINGS

FIG. 1 is a flowchart of a method for estimating a state-of-charge of a PCM TES and optimizing said TES thereto;

FIG. 2a is a graph of a raw signal of ultrasound traversing the phase change material in a liquid phase;

FIG. 2b is a graph of the signal of FIG. 2a having passed through a low pass filter; FIG. 2c is a graph showing the Fourier transform of the signal of FIG. 2a and the signal of FIG. 2b;

FIG. 2d is a graph of an absolute value of the signal of FIG. 2a;

FIG. 3a is a graph of a raw signal of ultrasound traversing the phase change material in a solid phase;

FIG. 3b is a graph of the signal of FIG. 3a having passed through a low pass filter;

FIG. 3c is a graph showing the Fourier transform of the signal of FIG. 3a and the signal of FIG. 3b;

FIG. 3d is a graph of an absolute value of the signal of FIG. 3a;

FIG. 4a is a graph of a raw signal of ultrasound traversing the phase change material in a combined solid and liquid phase whilst melting;

FIG. 4b is a graph of the signal of FIG. 4a having passed through a low pass filter;

FIG. 4c is a graph showing the Fourier transform of the signal of FIG. 4a and the signal of FIG. 4b;

FIG. 4d is a graph of an absolute value of the signal of FIG. 4a;

FIG. 5 is a graph showing a relationship between a speed of sound and a light intensity against a solidification of the phase change material over time;

FIG. 6 is a schematic diagram of a system for estimating a state-of-charge of a PCM TES and controlling thereto;

FIG. 7a is a graph showing a relationship between a light intensity against a change of temperature in a first range of the phase change material over time;

FIG. 7b is a graph showing a relationship between a light intensity against a change of temperature in a second range of the phase change material over time;

FIG. 7c is a graph showing a relationship between a speed of sound against a change of temperature in the first range of the phase change material of a second quantity over time;

FIG. 7d is a graph showing a relationship between a light intensity against a change of temperature in a first range of the phase change material of a second quantity over time;

FIG. 8a shows a PCM TES of the pillow plate type;

FIG. 8b shows an enlargement of a section of the plates of the pillow plate type PCM TES of FIG. 8a;

FIG. 8c shows a perspective view of a section of a pillow plate of the pillow plate type PCM TES of FIG. 8a;

FIG. 9a. shows a perspective view of a PCM TES of an extruded tube-in-tube type; and

FIG. 9b shows a cross-sectional view of the extruded tube-in-tube type PCM TES.

FIGS. 10a and 10b show a system for estimating a state-of-charge of a PCM TES incorporated into a PCM TES having a container forming an inner volume, and at least one hollow heat exchange coil located inside the container.

### DETAILED DESCRIPTION

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art.

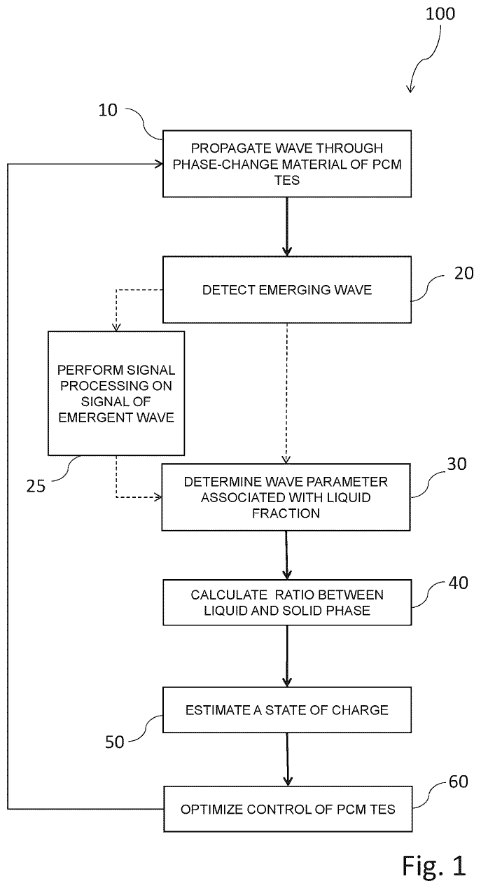

With reference to FIG. 1 showing a flowchart 100 of a method for estimating a state-of-charge of a phase change material (PCM) thermal storage system (TES), the method starts at 10 wherein a wave is propagated through the PCM of the TES.

In a first example of the invention, the wave is an ultrasound wave. The ultrasound wave is generated using a transducer, such as a commercially available transducer. For example, a 1.0 MHz transducer with a width of 12.7 mm, and a depth of 16 mm (e.g., a transducer supplied by Accuscan®) may be used. In another example, a 0.5 MHz transducer with a width of 25.4 mm, and a depth of 16 mm (e.g., a transducer supplied by Videoscan®) may be used. The method is render cost-effective by the ability to use commercially available components available at reasonable prices.

In a second example of the invention, the wave is an electromagnetic wave. In particular, the wave is an electromagnetic wave in the visible spectrum at around 400 nm to 700 nm, or in the ultraviolet spectrum at around 10 nm to 400 nm.

Preferably, the electromagnetic wave is generated by a light emitting diode (LED). LED diodes in the visible spectrum are inexpensive and readily available rendering the method cost-efficient.

At step 20, the wave which propagated through the PCM is detected. Whilst propagating through the PCM, the wave will be disturbed by the material by refraction, reflection and absorption. The amount of disturbance to the original wave will depend on a ratio of liquid to solid phase of the PCM. The amount of disturbance to the original wave is observable in the detected emergent wave. In particular, boundaries between a liquid fraction and a solid fraction in the PCM will result in significant disturbance to the original wave.

In the example wherein the propagated wave is an ultrasound wave, the emergent wave is detected by an ultrasound probe located on a second side of the PCM from the transducer and laterally aligned.

In the example wherein the propagated wave is an electromagnetic wave, an intensity of the emergent wave is detected by a photoresistor.

At step 30, a parameter of the wave which can be used to calculate a liquid fraction of the PCM is determined.

In the example wherein the wave is an ultrasound wave, the parameter which can be used to calculate a liquid fraction of the PCM is a speed of sound through the PCM. To determine the speed of sound from the detected emergent ultrasound wave, an intermediate signal processing step 25 needs to be performed. A raw signal is processed by first applying a low pass filter to filter out a majority of signal noise. Next, a Fourier transform is applied to the signal to find a signal peak. Then, a B-spline curve is fitted to a graph of absolute value of the signal against time. A time-of-flight (TOF), that is the time that the wave took to propagate from the transmitter to the receiver, is then indicated by a peak of the B-spline curve.

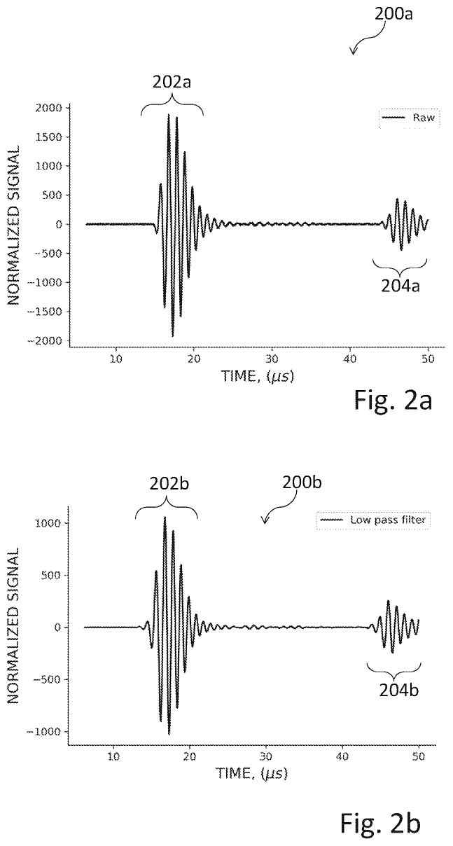

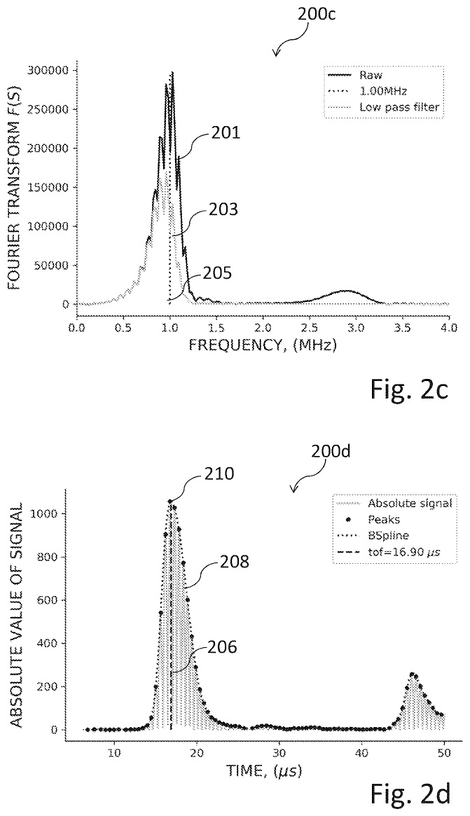

FIGS. 2a to 2d show graphical representations of the signal processing steps of step 25 of the method 100, in a particular example experimental setup wherein ultrasound is propagated through PCM in a liquid phase. In the particular example experimental setup of FIGS. 2a to 2d, 200 ml of the PCM were used, wherein the PCM was Croda Therm-37®, and the transmitter and receiver were at a distance of 20 mm. With reference first to FIG. 2a, the graph of the normalized signal of the raw data against a time in microseconds (μs) is shown. The initial waveform 202a of highest amplitude is of the true ultrasound pulse, whereas the second waveform 204a is a signal derived from the pulse echo. FIG. 2b shows the signal after application of the low pass filter. The first waveform 202b is the ultrasound pulse and the second waveform 204b is the pulse echo. The low pass filter filters out signal noise. As can be seen from the similarities between the signal of the raw data in FIG. 2a and the signal after low pass filter in FIG. 2b, ultrasound in PCM in the liquid phase produces a relatively clear signal. The graph in FIG. 2c shows the Fourier transform of the raw signal 201 in FIG. 2a and the low pass filter signal 203 in FIG. 2b. The graph 200c has a peak frequency of 1.00 MHz as shown by reference line 205. The graph 200d in FIG. 2d shows the absolute value of the signal plotted against time. A B-spline curve 208 is curve-fitted to the peaks 210 of the graph, and the TOF found from a peak of the B-spline curve. As shown in FIG. 2d, the TOF is calculated at 16.57 μs. Since the distance between the ultrasound transmitter and the ultrasound detector is known (in this example the distance was 20mm) the sound speed can be calculated. The speed of sound associated with signal 200a through the PCM in its liquid phase was calculated at 1207 ms⁻¹.

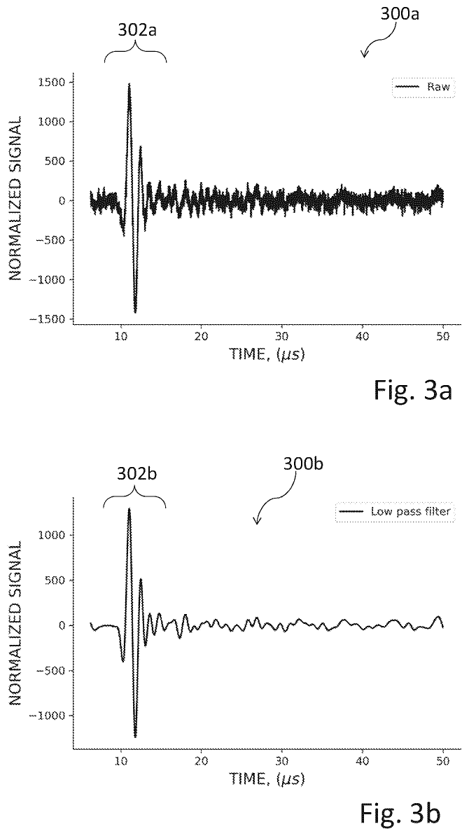

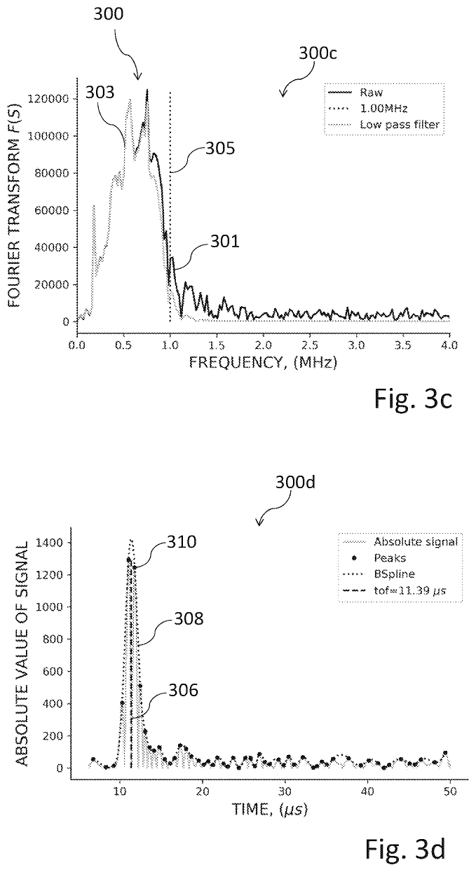

FIGS. 3a to 3d show graphical representations of the signal processing steps 25 of a detected ultrasound signal having propagated through the PCM in solid phase, in a particular example experimental setup. Parameters of the particular example experimental setup were the same as in FIGS. 2a to 2d i.e., 200 ml of Croda Therm-37®, with the transmitter and receiver at a distance of 20 mm. A TOF of the ultrasound wave through the PCM in the solid phase was 11.39 μs. As shown in FIG. 3c the Fourier transform 300c shows that the dominant frequency of the received signal was less than 1.00 MHz. As shown in FIG. 3d, the peak of the B-spline curve 308 lies between two signal peaks 310. The speed of sound associated with signal 300a through the PCM in its solid phase was 1756 ms⁻¹.

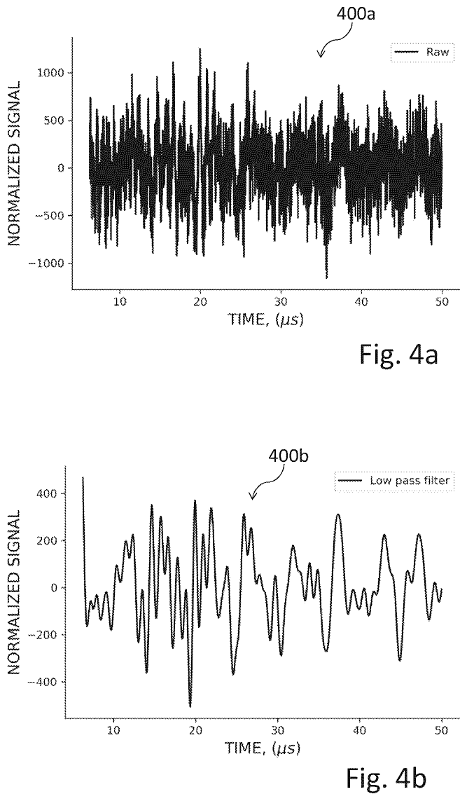

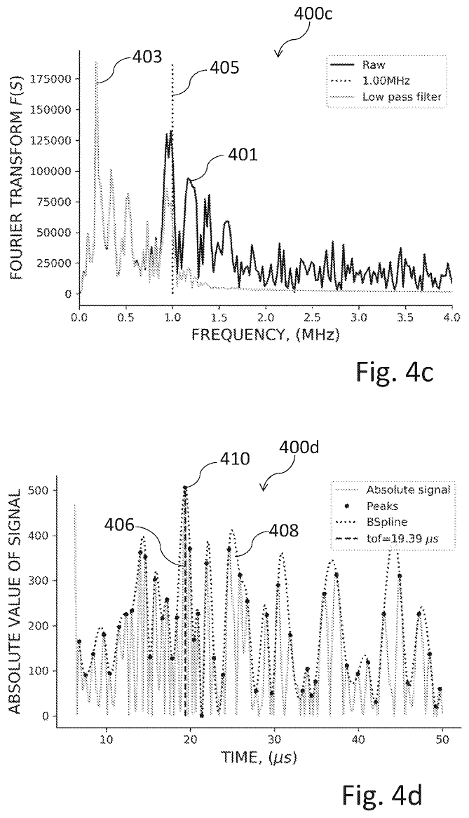

FIGS. 4a to 4d show graphical representations of the signal processing steps 25 of a detected ultrasound signal having propagated through the PCM in a combined solid and liquid phase whilst melting, in a particular example experimental setup having the same parameters as for FIGS. 2a to 3d. FIG. 4a shows a graph 400a of the raw signal plotted against time. The graph 400a shows that the ultrasound wave is significantly distorted when traversing the combined solid and liquid phase whilst melting occurs and this gives rise to a noisy detected signal.

This is because there is a plethora of solid-liquid boundaries across the PCM which deflect the ultrasound wave. The graph 400d in FIG. 4d shows the B-spline curve 408 fitted to the signal peaks 410. The peak 406 of the B-spline curve is at a time of 10.31 μs, thus, the TOF of the ultrasound wave through the PCM in a combined solid and liquid phase whilst melting is 10.31 μs. Hence, for this particular example experimental setup, the sound speed of the ultrasound wave through the PCM in a combined solid and liquid phase whilst melting was 1939 ms⁻¹.

In the example wherein the wave is an electromagnetic wave, the wave parameter associated with a liquid fraction of the PCM to be determined is an intensity of light of the detected signal. This can be measured directly by a photoresistor.

At step 40 of the method 100, using the calculated wave parameter(s) of step 30 (i.e., sound speed or light intensity, or both), a ratio between a liquid and a solid phase of the PCM (the liquid fraction) is calculated at the point in time in which the associated n^{th} wave propagated the PCM (time tₙ).

At step 50, the calculated liquid fraction at time tₙ is used to estimate a state-of-charge of the PCM TES at that time tₙ.

At step 60, the state-of-charge at time tₙ is analyzed to optimize a usage of the TES. For example, a heat output of the TES may be increased or decreased depending on the TES state-of-charge. In order to control the heat output of the TES, a temperature of a circulating fluid upstream from the TES can be adjusted. Alternatively or additionally, a flow rate of the circulating fluid upstream from the TES can be adjusted. Yet further alternatively or in combination with adjusting temperature and/or flow rate of the circulating fluid, the pressure of the circulating fluid upstream from the TES can be adjusted.

The method then returns to step 10, wherein a subsequent wave, the (n+1)^{th} wave, is propagated through the PCM at a new time tₙ₊₁. The method then cycles through steps 20 to 60 for the subsequent (n+1)^{th} wave. The state-of-charge may have changed since time tₙ and thus the TES may need to be adjusted. The need for the TES to be adjusted is analyzed at step 60 of optimizing the PCM TES. For example, a heat output of the TES may be reduced.

The method 100 provides real-time analysis and optimization of the TES system. During each iteration of steps 10 to 50, the state-of-charge is stored against a timestamp (i.e., the time tₙ that the associated n^{th} wave propagated). In this way the state-of-charge is tracked over time. Firstly, this provides valuable information as to the charge history of the TES. Secondly, this provides information for use by a control system equipped with machine learning to extrapolated predicted future state-of-charge of the TES. Thirdly, the TES may be configured to automatically change its operational state according to the changing state-of-charge, and optionally according also to other factors such as time of day, energy demand etc.

The invention further has a method of controlling a functioning of a phase change material thermal energy storage system having a variable heat output, comprising first performing the steps of method 100 of measuring a state of charge of a phase change material thermal energy storage system. Then a range of heat output rates for the measured state of charge at the corresponding time intervals can be retrieved from a database. A heat output of the thermal energy storage system is then compared with the retrieved range of heat output rates for the measured state of charge at the corresponding time interval. When it is determined that the heat output is outside the retrieved range, the heat output can be adjusted to lie within the retrieved range at the corresponding time interval. The above steps can be performed repeatedly at predetermined time intervals to continuously control a heat output of the phase change material thermal energy storage system.

The steps of method 100 can be repeated and the state of charge continuously recorded against retrieved heat output rate range and real heat output for each predetermined time interval against time to track a time-dependent state of charge. In this way a first trend in the state of charge of the thermal energy storage system can be tracked over time. Also trackable by the method and system of the invention is a second trend of real heat output compared to the retrieved heat output rates. Feeding the first and/or second trends into a machine learning program can be used to predict future values in state of charge and/or real heat output; and these the machine learning predictions can be incorporated into the controlling of the functioning of the phase change material thermal energy storage system.

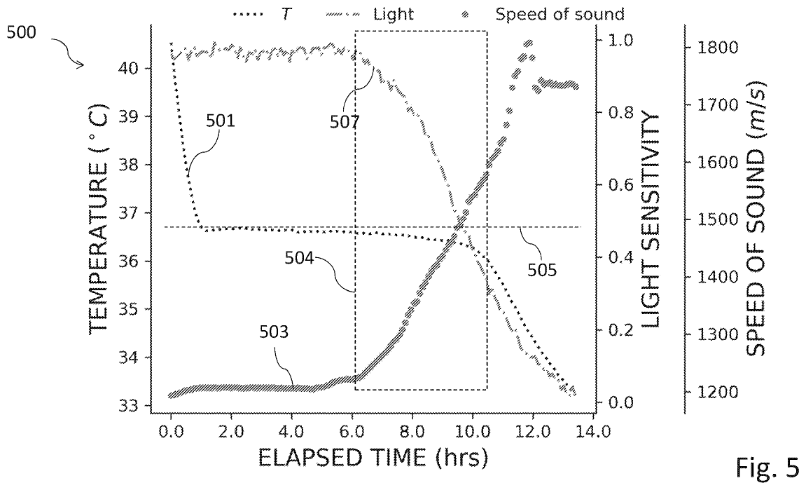

FIG. 5 shows a graphical representation 500 of a change in wave parameters associated with liquid fraction as the temperature of the PCM changes over time, in particular example experimental setups. A temperature 501 of the PCM decreases from around 41° C. to around 34° C. over approximately 14.0 hours.

Between approximately hour 2.0 and hour 10.0, the temperature flatlines 505 at around 37° C. During this time the PCM is phase transitioning from a liquid to a solid and, thus, the temperature alone is not a useful indication of the state-of-charge. However, as shown by the curve 503, the speed of sound varies during the phase transition period 504. In particular, the speed of sound increased substantially linearly from around 1200 ms-1 to 1550 ms-1 during the phase transition from a liquid to a solid. As shown by the curve 507, light intensity also varies during the phase transition period 504. The particular example experimental setup used for the production of graph 500 was 200 ml of Croda Therm-37®, and the transmitter and receiver were at a distance of 20 mm.

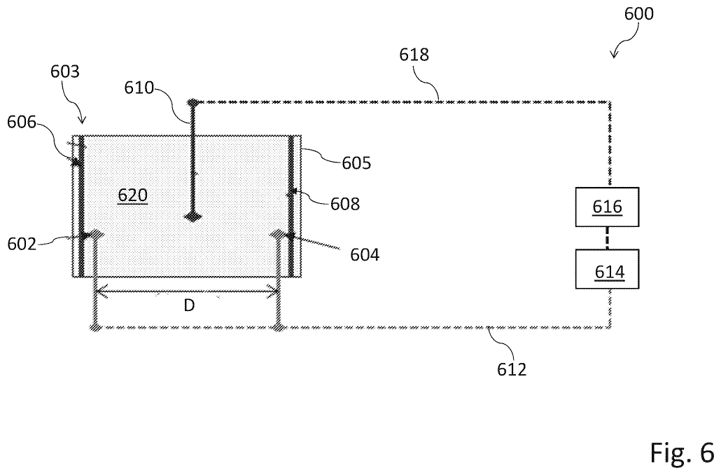

FIG. 6 is a schematic diagram of a system 600 for estimating a state-of-charge of a PCM TES and optimizing thereto. The system 600 is installed onto a PCM TES 603. The system 600 comprises a wave transmitter 602, a wave receiver 604, a signal processing module 614 and a control module 616. The wave transmitter 602 and the wave receiver 604 are in data communication with the signal processing module 614. The signal processing module 614 is in data communication with the control module 616. The PCM TES 603 has a main container 605, the container holds a PCM 620, for example Croda Therm-37®. The PCM may also have a first heat source/sink 606 in a first location (for example on a first side of the container 603) and another heat sink/source 608 in a second location at a distance from the first heat source/sink (for example on a second, opposite side of the container 603), for example to establish a thermal gradient between the first and second sides of the container 603. In the example of FIG. 6, the wave transmitter 602 is positioned proximate the first side, adjacent the heat source/sink 606, and the wave receiver 604 is positioned proximate to the second side, adjacent the heat sink/source 608, and laterally aligned with the wave transmitter 602. In this way, a path from the wave transmitter 602 to the wave receiver 604 is along a thermal gradient. This prevents disturbance to the propagating wave which would occur from a thermal gradient which intercepts the wave path at an angle. The wave transmitter 602 and the wave receiver 604 are separated by a distance D. Although heat sink/source 606 and heat source/sink 608 have been shown in FIG. 6 to be at either ends of the container, these heat sink/sources 606, 608, and further heat sink/sources may be placed anywhere in the container provided the wave transmitter and receiver are position with respect to said heat sink/sources to lie along a thermal gradient produced by the heat sink/sources and PCM. Thermal gradients can arise in PCM TES systems due to several factors associated with the phase change process of the PCM. The presence of heat sources or sinks can influence the temperature distribution within the PCM. Variations in ambient temperature or the proximity of heat sources can create non-uniform heating or cooling effects.

In some examples of the invention, the system includes a thermocouple 610. Since the energy stored in a PCM is a combination of its sensible heat and its latent heat, the thermocouple 610 can measure the sensible heat. This information can then be used in combination with the liquid fraction to provide a more accurate estimate of the state-of-charge of the TES.

As mentioned above, the wave propagated through the PCM may be an ultrasound wave or an electromagnetic wave. In the example wherein the wave is an ultrasound wave, the wave transmitter is a transducer and the wave receiver is an ultrasound receiver. In the example wherein the wave is an electromagnetic wave, the wave transmitter is preferably a white LED or the outlet of an optical fiber and the wave receiver is a photoresistor.

In some examples of the invention, the system 600 has more than one wave transmitter and more than one corresponding receiver. The transmitters and receivers can be separated laterally such that a corresponding plurality of waves propagate through different sections of the PCM. The wave propagation parameters from each of the more than one receiver can then be averaged. In a particular example of a system with more than one wave transmitter and more than one wave receiver, the system has three LEDs and three photoresistors. A first LED of the three LEDs is proximate a top of the PCM TES container 605, a second LED is proximate a bottom of the container 605, and a third LED is position substantially equidistant between the first LED and the second LED. Correspondingly, a first photoresistor is positioned proximate the top of the PCM TES container 605 and aligned with the first LED, a second LED is proximate the bottom of the container 605 and aligned with the second LED, and a third LED is position substantially equidistant between the first LED and the second LED and aligned with the third LED. In an alternative arrangement, instead of a series of LEDs, the more than one transmitter comprises multiple outlets of an optical fibre. This arrangement may provide a more compact solution.

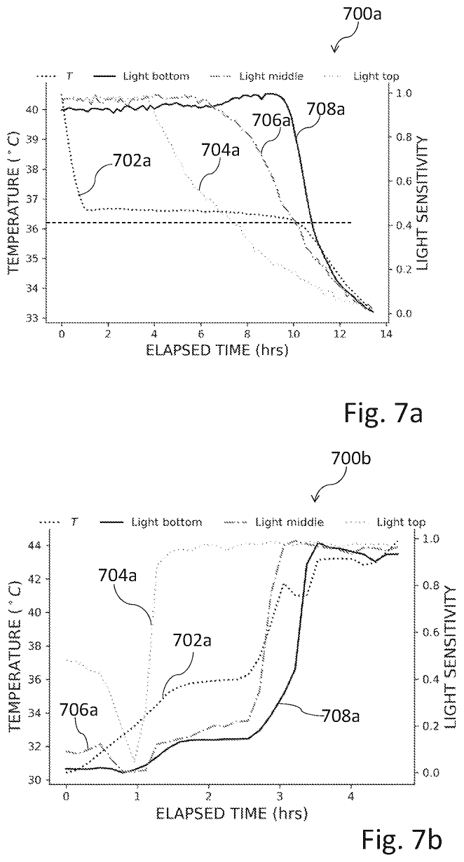

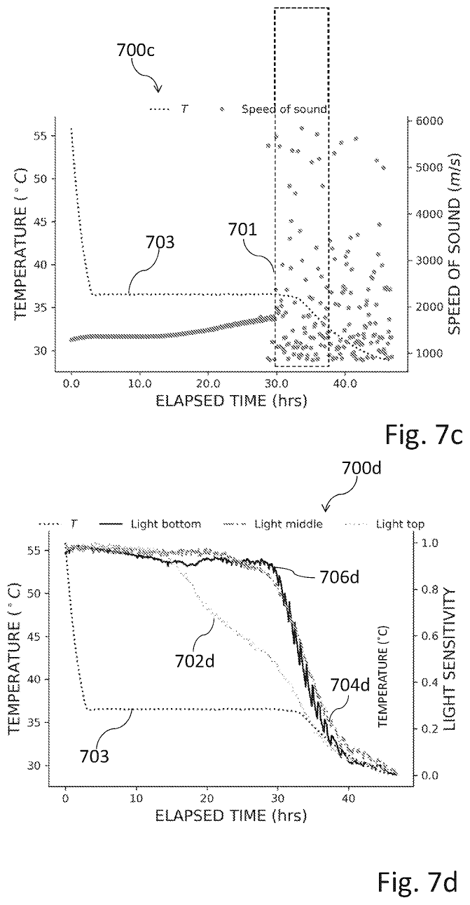

FIGS. 7a, 7b and 7d show graphs of light intensity over time through a PCM in an experimental set-up emulating the three LED system as described above. FIG. 7a shows change in light intensity at the three separate positions as the phase change material solidifies over time. FIG. 7b shows change in light intensity at the three separate positions as the phase change material melts over time. FIG. 7d shows a change in light intensity at the three separate positions as the phase change material solidifies over time for a second quantity of PCM to that of FIG. 7a. Some of the benefits of this arrangement include accommodating differences at the different positions, having the utility of multiple transmitter/receiver pairs to survey the entire PCM space, and the ability to average solid/liquid fraction from all of the pairs.

With particular reference to FIGS. 7c and 7d, both show graphical representations, for a particular example experimental setup, of the change in the wave parameter as the PCM transitions from a liquid phase to a solid phase over time. However, in this particular example experimental setup, a larger quantity of 600ml of the PCM was used, and the transmitter and receiver were at a greater distance of 42.5 mm. As shown by section 701 of graph 700c indicating the phase transition, a random spread of speed of sound results is recorded. Whereas in graph 700d of FIG. 7d, the light intensity decreases substantially linearly across the phase transition. This suggests that using light intensity for the wave parameter to calculate state-of-charge may be more useful in system wherein a distance between the transmitter and receiver is greater than around 30 mm. Thus, depending on the PCM TES type, the system 600 using ultrasound or the system 600 using visible light may be more suitable.

In a particular example of the invention, there may be more than one transmitter-receiver pair and the more than one transmitter-receiver pairs may use different wave-types. For example, the system 600 may have a plurality of LED-photoresistor pairs and a plurality of transducer-ultrasound receiver pairs distributed through a PCM TES. The method may combine the calculation of liquid to solid phase ratio derived from light intensity and liquid to solid phase ratio derived from sound speed. Thus, the system 600 may be adapted accordingly and have combine one transmitter-receiver pair for sound speed measurements and one transmitter-receiver pair for light intensity measurements.

The invention further includes a system for controlling a functioning of a phase change material thermal energy storage system having a variable heat output, comprising: the system 600 for estimating a state-of-charge of a PCM TES, and a database comprising a plurality of predefined heat output rates ranges for a plurality of corresponding state of charge values. The control module may further comprises a comparison module comprising computer readable media with instruction that, when executed on a processor, perform the task of comparing a heat output of the thermal energy storage system with the retrieved range of heat output rates for the measured state of charge at the corresponding time interval; and wherein, when it is determined that the heat output is outside the retrieved range, the control module is further configured to adjusting the heat output to lie within the retrieved range at a corresponding time interval.

In an illustrative example, the system of the invention measures a state-of-charge of the PCM TES at a certain time interval to be 70%. The system then accesses the database that provides a range of heat output rates for different states-of-charge. For our example, the database provides the following range for a state-of-charge of 70% of a minimum heat output of 300 kW and a maximum heat output of 400 kW. Wherein the system measures heat output at, for example, 450 kW, this is outside a retrieved range. Thus, the system will adjust the heat output to fall within the retrieved range.

In some examples, the control module further has a trend tracking module having computer readable media with instruction that, when executed on a processor, perform the task: tracking a first trend in the state of charge of the thermal energy storage system over time; and/or tracking a second trend in real heat output compared to the retrieved heat output rates. In some examples the control module has a machine learning module configured to utilise the first and/or second trends to create predictions on a further state of charge/heat output of the system and control a functioning of a phase change material thermal energy storage system accordingly.

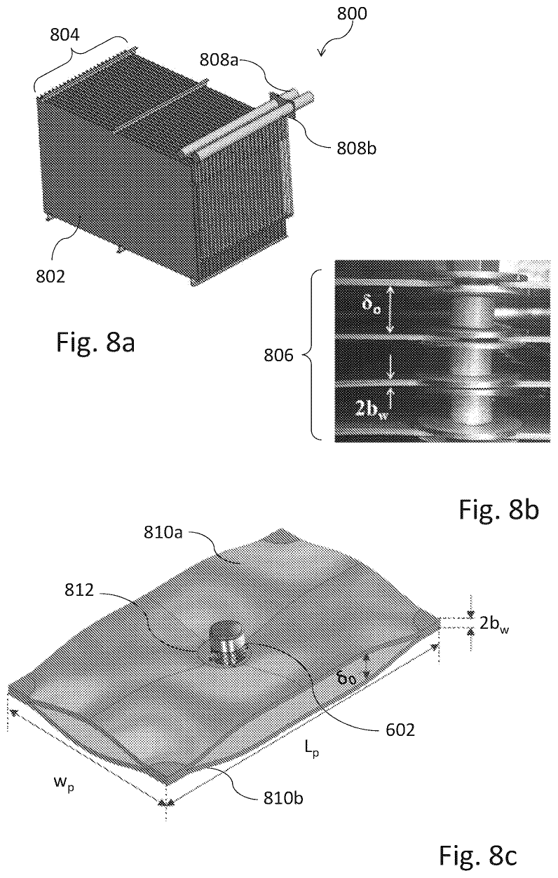

The system 600 may be particularly suitable for a PCM TES of the pillow plate type, as shown in FIG. 8a. A pillow plate type PCM TES 800 has a container 802, a heat exchanger 804 disposed within the container 802, and a PCM disposed within the container such that the heat exchanger is immersed in the PCM as with other types of PCM TES. However, and as more clearly shown in FIG. 8b, the heat exchanger of a pillow plate type PCM TES comprises a number of plates 806 arranged in parallel. The plates are in fluid communication with an inlet pipe 808a and an outlet pipe 808b of the heat exchanger 804. Typically, each plate in the number of plates 806 has a separate flow path for heat exchanger fluid from the inlet pipe 808a to the outlet pipe 808b. The plates are separated from each other by a distance of δ₀. The distance δ₀ is in the range of 10 mm to 50 mm, preferably 15 mm to 45 mm. Wave type selection for the system 600 may depend on an opacity of the PCM. For example, visible light waves will not penetrate an opaque PCM and thus would not be appropriate for TES having opaque PCM. In this case ultrasound can be selected whose penetration of PCM is not prevented by its opacity. Other aspects of the PCM may influence the choice of wave type selection such as melting congruency. In some examples of the invention, TES arrangement and type, and wave source arrangement and size, may influence wave type selection.

As shown in FIG. 8c, each plate is made up of two surfaces 810a, 810b which are joined at their edges and also pinched together to create recesses 812 across the surfaces. At these recesses 812 the two surfaces may have been welded or riveted together. The system 600 is incorporated into the pillow plate TES by positioning the wave transmitter 602 into one of the recesses on one of the plurality of parallel plates and positioning the receiver (not shown) into one of the recesses on a neighboring parallel plate. Depending on the accuracy of the state-of-charge required, further transmitters can be positioned in further recesses of the parallel plate and further receivers into the recesses of the neighboring parallel plate. State-of-charge accuracy may also be improved across a length of the TES by positioning further transmitter-receiver pairs in recesses of further neighboring parallel plates in the plurality of parallel plates.

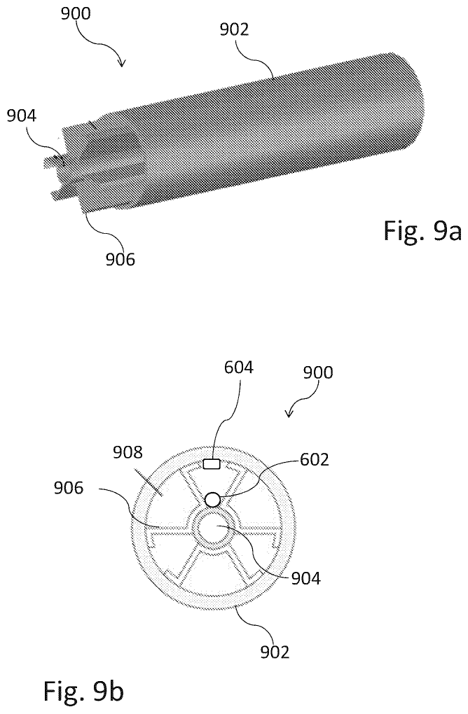

The system 600 may also be incorporated into a PCM TES of an extruded tube-in-tube type, as demonstrated in FIGS. 9a and 9b. The tube-in-tube PCM TES 900 has a hollow inner tube 904, an outer tube 902 and several internal fins 906 which extend radially from the inner tube 904 to the outer tube 902. In use, a first heat exchanger fluid flows through the inner tube 904. Voids between the internal fins and the outer tube are filled with PCM 908. A second heat exchanger fluid flows around the outer tube 902. In some examples, the first heat exchanger fluid (e.g., heating fluid) is different from the second heat exchanger fluid (e.g., cooling fluid) such that the system is a three-fluid heat exchanger. As further shown in FIG. 9b, the wave transmitter 602 is affixed to an outer surface of the inner tube 904 and the wave receiver 604 is affixed to an inner surface of the outer tube 902. The transmitter-receiver pair are both axially and radially aligned. Depending on the accuracy of the state-of-charge required, a plurality of transmitter-receiver pairs can be positioned axially along the tube-in-tube TES. Typically, a tube-in-tube TES comprises a plurality of the tube-in-tubes 900 in a bundle, in which case each of the tube-in-tubes in the bundle may incorporate the system 600. The tube-in-tube 900 may have an outer diameter in the range of 20 mm to 50 mm, preferably 30 mm to 40 mm. Thus, the system 600 using both an ultrasound wave source and/or a visible light wave source may be suitable for use with the tube-in-tube TES.

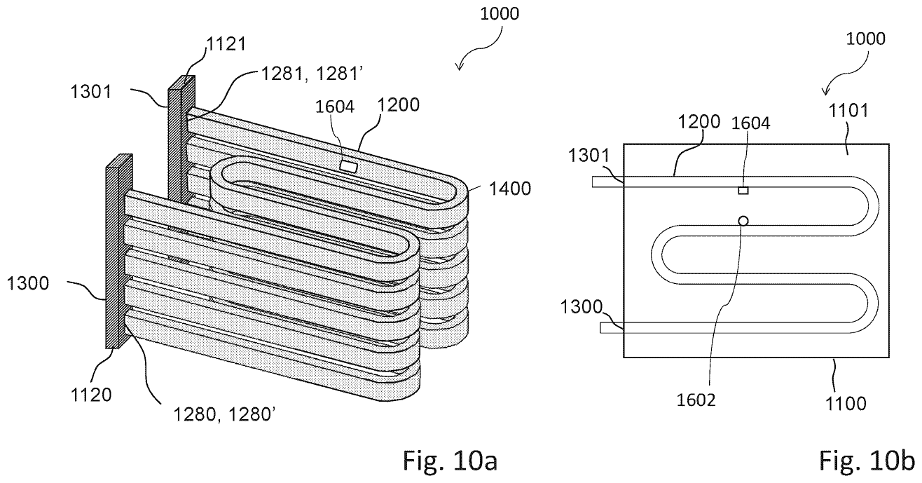

FIGS. 10a and 10b show the system 600 incorporated into a PCM TES 1000 having a container 1100 forming an inner volume 1101, and at least one hollow heat exchange coil 1200 located inside the container 1100. The heat exchange coil 1200 is connected at a first end 1280 to a port 1280′ located on a first manifold 1300. The heat exchange coil 1200 is further connected at a second end 1281 to a port 1281′ located on a second manifold 1301. The first manifold 1300 includes a fluid inlet 1120 in fluid communication with each port 1280′ of the first manifold 1300. The second manifold 1301 includes a fluid outlet 1121 in fluid communication with each port 1281′ of the second manifold 1301. The heat exchange coils 1200 extend substantially perpendicular to the manifold 1300, 1301. A wave transmitter 1602 is affixed to an outer surface of the heat exchange coil 1200 and a wave receiver 604 is affixed to the outer surface outer surface of the heat exchange coil 1200, at a location of alignment with the wave transmitter 1602. Further of transmitter-receiver pairs can be positioned on a subsequent heat exchange coil and/or in a separate turn of the coil.

Having described preferred examples of the invention it will be apparent to those skilled in the art that other embodiments incorporating the invention may be used. These and other examples of the invention illustrated above are intended by way of example only and the actual scope of the invention is to be determined from the appended claims.

1. A method for measuring a state of charge of a phase change material thermal energy storage system and optimising the system thereto, comprising:
propagating a wave through at least a majority of a phase change material along a thermal gradient of the phase change material thermal energy storage system, wherein a property of said wave is dependent on the medium through which it propagates;
detecting the emerging wave after it has propagated through at least the majority of the phase change material along the thermal gradient;
determining a wave parameter of the emerging wave, said wave parameter associated with a liquid fraction of the phase change material;
calculating a ratio between a liquid and solid state of the phase change material using the wave parameter associated with the liquid fraction;
using the calculated ratio to estimate a state of charge of the phase change material thermal energy storage system at a time of propagation of the emergent wave.

2. The method of claim 1, further comprising controlling a heat output of the phase change material thermal energy storage system based on the calculated state of charge, wherein controlling the heat output comprises:
adjusting a temperature of a circulating fluid upstream from the thermal energy storage system; and/or
adjusting a flow rate of the circulating fluid upstream from the thermal energy storage system; and/or
adjusting a pressure of the circulating fluid upstream from the thermal energy storage system.

3. The method of claim 2, comprising continually repeating the steps of claim 1 and 2 for continual monitoring of the state of charge of the phase change material thermal energy storage system and corresponding continuous control of the heat output.

4. The method of claim 3, wherein the continual monitoring of the state of charge and the continuous control of the heat output occurs in real-time or periodically.

5. The method of claim 1, wherein the wave to be propagated through at least the majority of the phase change material is an ultrasound wave, and the corresponding wave parameter is a speed of sound.

6. The method of claim 1, wherein the wave to be propagated through at least the majority of the phase change material is an electromagnetic wave in the visual or ultraviolet spectrum, and the corresponding wave parameter is a light intensity.

7. The method of claim 5, further comprising an additional signal processing step to extract the speed of sound from a signal of the emergent ultrasound wave.

8. The method of claim 7, wherein, the additional signal processing step comprises:
performing a low pass filter on the signal;
performing a Fourier transform on the low pass filter processed data to identify a signal peak; and
deriving a time-of-flight of the propagating wave.

9. The method of claim 1, further comprising measuring a sensible temperature via a thermocouple and incorporating the sensible temperature measurement for calculating the state of charge.

10. The method of claim 1, further comprising using a combination of ultrasound waves and electromagnetic waves.

11. A method of controlling a functioning of a phase change material thermal energy storage system having a variable heat output, comprising:
a) performing the steps of measuring a state of charge of a phase change material thermal energy storage system comprising;
propagating a wave through at least a majority of a phase change material along a thermal gradient of the phase change material thermal energy storage system, wherein a property of said wave is dependent on the medium through which it propagates;
detecting the emerging wave after it has propagated through at least the majority of the phase change material along the thermal gradient;
determining a wave parameter of the emerging wave, said wave parameter associated with a liquid fraction of the phase change material;
calculating a ratio between a liquid and solid state of the phase change material using the wave parameter associated with the liquid fraction;
using the calculated ratio to estimate a state of charge of the phase change material thermal energy storage system at a time of propagation of the emergent wave; and
b) retrieving a range of heat output rates for the measured state of charge at the corresponding time interval from a database;
c) comparing a heat output of the thermal energy storage system with the retrieved range of heat output rates for the measured state of charge at the corresponding time interval; and
d) when it is determined that the heat output is outside the retrieved range, adjusting the heat output to lie within the retrieved range at the corresponding time interval; and
repeatedly performing steps a to d at predetermined time intervals to continuously control a heat output of the phase change material thermal energy storage system.

12. The method of claim 11, further comprising continuously recording state of charge, retrieved heat output rate range and real heat output for each predetermined time interval;
tracking a first trend in the state of charge of the thermal energy storage system over time;
tracking a second trend in real heat output compared to the retrieved heat output rates; and
feeding the first and/or second trends into a machine learning program to predict future values in state of charge and/or real heat output; and
incorporating the machine learning predictions into controlling a functioning of a phase change material thermal energy storage system.

13. A system for measuring a state of charge of a phase change material thermal energy storage system and optimising thereto, comprising:
at least one wave transmitter of a first type;
at least one wave receiver of a first type;
wherein each of the at least one transmitter and each of the at least one receiver are configured to lie along a thermal gradient;
a signal processing module comprising instructions that, when executed on a processor, perform the steps of:
converting a wave signal into a state of charge; and
a control module for controlling a functioning of the phase change material thermal energy storage system.

14. The system of claim 13, further comprising at least one thermocouple and wherein the signal processing module further comprises instructions that, when executed on a processor, perform the step of utilising the voltage measured by the thermocouple to provide a more accurate estimate of the total state of charge of the phase change material thermal energy storage system.

15. The system of claim 13, wherein the at least one wave transmitter of a first type is an ultrasound transducer, and the at least one wave receiver of a first type is an ultrasound detector.

16. The system of claim 13, wherein the at least one wave transmitter of a first type is a light-emitting diode, and the at least one wave receiver of a first type is a photoresistor.

17. The system of claim 13, further comprising at least one transmitter of a second type wherein the at least one wave transmitter of a first type is a light-emitting diode, and at least one wave receiver of a second type wherein the at least one wave receiver of a first type is a photoresistor.

18. A system for controlling a functioning of a phase change material thermal energy storage system having a variable heat output, comprising:
at least one wave transmitter of a first type;
at least one wave receiver of a first type;
wherein each of the at least one transmitter and each of the at least one receiver are configured to lie along a thermal gradient;
a signal processing module comprising instructions that, when executed on a processor, perform the steps of:
converting a wave signal into a state of charge; and
a control module for controlling a functioning of the phase change material thermal energy storage system;
a database comprising a plurality of predefined heat output rates ranges for a plurality of corresponding state of charge values; and
wherein the control module further comprises:
a comparison module comprising computer readable media with instruction that, when executed on a processor, perform the task of comparing a heat output of the thermal energy storage system with the retrieved range of heat output rates for the measured state of charge at the corresponding time interval; and
wherein, when it is determined that the heat output is outside the retrieved range, the control module is further configured to adjusting the heat output to lie within the retrieved range at a corresponding time interval.

19. The system of claim 18, wherein the control module further comprises:
a trend tracking module comprising computer readable media with instruction that, when executed on a processor, perform the task:
tracking a first trend in the state of charge of the thermal energy storage system over time; and/or
tracking a second trend in real heat output compared to the retrieved heat output rates; and
a machine learning module configured to utilise the first and/or second trends to create predictions on a further state of charge/heat output of the system and control a functioning of a phase change material thermal energy storage system accordingly.

20. A self-monitoring phase change material thermal energy storage system comprising:
a container;
a phase change material contained within said container;
at least one heat sink or heat source in a first location in the container;
at least another heat sink or heat source at a second location in the container at a distance from the at least one heat sink or heat source; and
a system for measuring a state of charge of a phase change material thermal energy storage system and optimising thereto, comprising:
at least one wave transmitter of a first type;
at least one wave receiver of a first type;
wherein each of the at least one transmitter and each of the at least one receiver are configured to lie along a thermal gradient;
a signal processing module comprising instructions that, when executed on a processor, perform the steps of:
converting a wave signal into a state of charge; and
a control module for controlling a functioning of the phase change material thermal energy storage system
wherein each of the at least one transmitter is located proximate to the at least one heat source or heat sink and each of the receiver is located proximate to the at least another heat sink or heat source and laterally aligned such that each of the at least one transmitter and each of the at least one receiver are configured to lie along a thermal gradient.

21. The thermal energy storage system of claim 20, comprising the system of claim 14 wherein the thermocouple is substantially centrally located within the phase change material.

22. A pillow plate type self-monitoring phase change material thermal energy storage system comprising:
a plurality of parallel plates each plate comprised of two sheets welded together with a pattern of embossed impressions;
a system for measuring a state of charge of a phase change material thermal energy storage system and optimising thereto, comprising:
at least one wave transmitter of a first type;
at least one wave receiver of a first type;
wherein each of the at least one transmitter and each of the at least one receiver are configured to lie along a thermal gradient;
a signal processing module comprising instructions that, when executed on a processor, perform the steps of:
converting a wave signal into a state of charge; and
a control module for controlling a functioning of the phase change material thermal energy storage system;
wherein the at least one wave transmitter of a first type comprises a plurality of wave transmitters of the first type, positioned in at least two of embossed impressions of at least a first plate of the plurality of parallel plates; and
wherein the at least one wave receiver of a first type comprises a plurality of corresponding wave receivers of the first type, positioned in at least two of the embossed impressions of a neighbouring plate of the first plate.

23. An extruded tube-in-tube type self-monitoring phase change material thermal energy storage system comprising:
an inner tube, an outer tube and a plurality of internal fins which extend radially from the inner tube to the outer tube;
a system for measuring a state of charge of a phase change material thermal energy storage system and optimising thereto, comprising:
at least one wave transmitter of a first type;
at least one wave receiver of a first type:
wherein each of the at least one transmitter and each of the at least one receiver are configured to lie along a thermal gradient;
a signal processing module comprising instructions that, when executed on a processor, perform the steps of:
converting a wave signal into a state of charge; and
a control module for controlling a functioning of the phase change material thermal energy storage system;
wherein at least one wave transmitter is affixed to an outer surface of the inner tube and is axially and radially aligned with at least one wave receiver affixed to an inner surface of the outer tube, creating at least one transmitter-receiver pair.
